(19) United States
(12) Patent Application Publication
(10) Pub. No.: US 2025/0246653 A1
(43) Pub. Date: Jul. 31, 2025

(54) FUEL CELL SYSTEM

(71) Applicant: TOYOTA JIDOSHA KABUSHIKI KAISHA, Toyota-shi (JP)

(72) Inventors: Makito OKUMURA, Nagoya-shi (JP); Ryouichi Namba, Okazaki-shi (JP); Koro Fujio, Toyota-shi (JP)

(73) Assignee: TOYOTA JIDOSHA KABUSHIKI KAISHA, Toyota-shi (JP)

(21) Appl. No.: 18/931,578

(22) Filed: Oct. 30, 2024

(30) Foreign Application Priority Data
Jan. 26, 2024 (JP) 2024-009900

(51) Int. Cl. H01M 8/04746; H01M 8/0438; H01M 8/04537

(52) U.S. Cl. CPC H01M 8/04753; H01M 8/04395; H01M 8/04552; H01M 2250/20

(57) ABSTRACT

A fuel cell system includes a fuel cell, an air compressor, a flow rate sensor, a voltage sensor, and a control unit, wherein the control unit performs either a raising operation of causing an air compressor to supply a cathode gas so as to achieve a first air stoichiometric ratio, or a lowering operation of causing the air compressor to supply the cathode gas so as to achieve a second air stoichiometric ratio lower than the first air stoichiometric ratio, and performs the raising operation when a first condition including that an output voltage is a value in a first range is satisfied, and does not perform the raising operation when a second condition including that the output voltage is a value in a second range higher than the first range is satisfied.

### CROSS-REFERENCE TO RELATED APPLICATION

This application claims priority to Japanese Patent Application No. 2024-009900 filed on Jan. 26, 2024, incorporated herein by reference in its entirety.

### BACKGROUND

### 1. Technical Field

The present disclosure relates to fuel cell systems.

### 2. Description of Related Art

In order to reduce degradation of a fuel cell, it is necessary to reduce drying of a stack. A fuel cell system of Japanese Unexamined Patent Application Publication No. 2020-4675 (JP 2020-4675 A) reduces drying of a stack by adjusting the amount of water that is generated per unit time by power generation. More specifically, in the fuel cell system according to JP 2020-4675 A, the amount of cathode gas to be supplied to the stack is reduced to reduce the amount of water to be removed by the cathode gas. This reduces drying of the stack.

In such a case, the air stoichiometric ratio is lower than usual. The air stoichiometric ratio is the ratio of the amount of cathode gas that is actually supplied to the stack to the minimum amount of cathode gas required to generate electric power requested from a load. The air stoichiometric ratio indicates that the smaller the air stoichiometric ratio, the smaller the amount of cathode gas that is supplied to the stack.

In the fuel cell system according to JP 2020-4675 A, the air stoichiometric ratio is kept at 1.0 or more. Therefore, the fuel cell system can generate requested electric power by supplying the amount of anode gas necessary to generate the requested electric power. When the air stoichiometric ratio varies, the electric power that is generated by the fuel cell also varies. When the generated electric power is more than or less than the requested electric power, a secondary battery in the fuel cell system discharges electric power to cover the shortage, or is charged with the surplus electric power.

A state in which the air stoichiometric ratio is lower than normal is a state in which water tends to stagnate in the stack. If excess water is generated in the stack, flooding occurs. Since flooding causes a concentration overvoltage, the fuel cell may not be able to output the requested electric power due to a decrease in output voltage. Therefore, the fuel cell system according to JP 2020-4675 A performs a drainage process before flooding occurs. The drainage process increases the amount of cathode gas that is supplied to the stack. As a result, water that is stagnant in the stack is removed.

### SUMMARY

However, the drainage process facilitates drying of the stack, and therefore may accelerate degradation of the fuel cell. Therefore, the inventors studied how to reduce the drainage process in a state where the air stoichiometric ratio is lower than normal.

However, the magnitude of the concentration overvoltage that is generated in the stack varies due to degradation of the stack over time, variation in quality of the stack, etc. Therefore, reducing the drainage process that is performed before flooding occurs makes it difficult to prevent or reduce the concentration overvoltage due to flooding. Accordingly, there has been a demand for a technique for reducing the possibility of insufficient fuel cell output while reducing drying of the stack.

The present disclosure can be implemented in the following aspects.
(1) An aspect of the present disclosure provides a fuel cell system. This fuel cell system includes
   a fuel cell,
   an air compressor that adjusts a flow rate of a cathode gas to be caused to flow into the fuel cell,
   a flow rate sensor that acquires the flow rate of the cathode gas,
   a voltage sensor that acquires an output voltage of the fuel cell, and
   a control unit that controls the fuel cell system.
   The control unit is configured to perform either a raising operation or a lowering operation. The raising operation is an operation in which the air compressor is caused to supply the cathode gas so as to achieve a first air stoichiometric ratio that is an air stoichiometric ratio of 1 or more. The lowering operation is an operation in which the air compressor is caused to supply the cathode gas so as to achieve a second air stoichiometric ratio that is an air stoichiometric ratio of 1 or more and less than the first air stoichiometric ratio.
   The control unit is configured to, when the lowering operation is being performed, perform the raising operation for a predetermined first period of time when a first condition is satisfied, and not perform the raising operation when a second condition is satisfied. The first condition includes that the output voltage has a value in a first range. The second condition includes that the output voltage has a value in a second range that is higher than the first range.
   The air stoichiometric ratio is the ratio of the amount of cathode gas that is actually supplied to a stack to the minimum amount of cathode gas required to generate requested electric power. For example, in order for the fuel cell to generate the requested electric power, the air compressor is controlled so that the air stoichiometric ratio becomes equal to or higher than 1. When the air stoichiometric ratio is the second air stoichiometric ratio, the flow rate of the cathode gas is lower than when the air stoichiometric ratio is the first air stoichiometric ratio. As a result, the amount of water that is removed from the fuel cell is reduced, so that drying of the fuel cell is reduced. However, when the air stoichiometric ratio is the second air stoichiometric ratio, the amount of water contained in the fuel cell is increased, which increases the possibility that a concentration overvoltage is caused by flooding. The concentration overvoltage reduces the output voltage of the fuel cell. In such a configuration, when the output voltage is in the first range due to the drop of the output voltage caused by the concentration overvoltage, the raising operation is performed so that the air stoichiometric ratio becomes the first air stoichiometric ratio. That is, the concentration overvoltage due to flooding is eliminated by increasing the flow rate of the cathode gas. The fuel cell system of the present disclosure controls the flow rate of the cathode gas in response to the drop of the output voltage caused by the concentration overvoltage. Drying of the fuel cell can therefore be reduced compared to a configuration in which the flow rate of the cathode gas is controlled so as not to cause the concentration overvoltage. Moreover, the fuel cell system of the present disclosure increases the flow rate of the cathode gas in response to the drop of the output voltage. Therefore, the output of the fuel cell is less likely to become insufficient.
(2) In the fuel cell system of the above aspect, the first condition may include that the output voltage is in the first range for a predetermined second period of time.
   With such a configuration, the raising operation will not be performed when the output voltage drops for less than the second period of time. The output voltage may instantaneously drop due to, for example, fluctuations in requested power. Therefore, the fuel cell system of the present disclosure can reduce the possibility of the raising operation being performed by mistake due to the instantaneous drop of the output voltage.
(3) In the fuel cell system of the above aspect, the control unit may perform the lowering operation after a lapse of the first period of time.

With such a configuration, the fuel cell system according to the present disclosure can reduce drying of the fuel cell compared to a configuration in which the lowering operation is not performed after the lapse of the first period of time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view showing a configuration of a fuel cell system according to a first embodiment;

FIG. 2 is a flow chart illustrating a control process for a fuel cell system; and

FIG. 3 is a waveform showing the output power of the fuel cell system when the output voltage drops.

### DETAILED DESCRIPTION OF EMBODIMENTS

### A. First Embodiment

### A-1. Configuration of Fuel Cell System

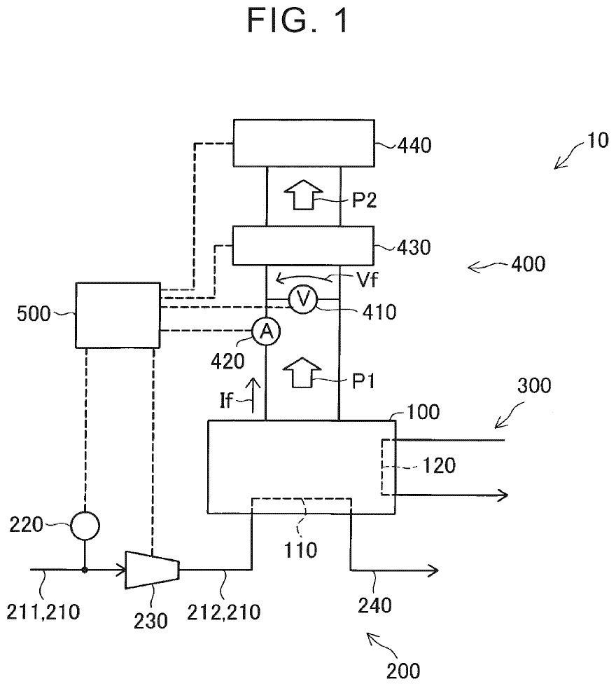

FIG. 1 is an explanatory diagram illustrating a configuration of a fuel cell system 10 according to a first embodiment. The fuel cell system 10 includes a fuel cell stack 100, a cathode gas supply/discharge system 200, an anode gas supply/discharge system 300, an output circuit 400, and a control unit 500. The fuel cell system 10 of the present embodiment is mounted on a battery electric vehicle, for example, and is used as a power source for driving or various devices.

The fuel cell stack 100 generates electric power by receiving the supply of the anode gas and the cathode gas as the reaction gas. For example, the anode gas is hydrogen and the cathode gas is air. The fuel cell stack 100 is a polymer electrolyte fuel cell, and has a stack structure in which a plurality of unit cells serving as a power generator are stacked. As used herein, a “fuel cell stack” is also simply referred to as a “fuel cell” or a “stack”.

The single cell includes Membrane Electrode Assembly (MEA), a pair of gas diffusion layers arranged to sandwich MEA, and a pair of gas separators arranged on the outer side of each gas diffusion layer. MEA includes an electrolyte membrane, and an anode and a cathode, which are catalytic electrode layers formed on respective surfaces of the electrolyte membrane. In each single cell, an anode gas flow path 120 through which the anode gas flows is formed on the anode side and a cathode gas flow path 110 through which the cathode gas flows is formed on the cathode side with the electrolyte membrane interposed therebetween. In FIG. 1, a single cell is omitted to facilitate understanding of the technology.

In the cathode, generated water is generated as the electrochemical reaction proceeds. This increases the amount of water contained in the cathode gas flow path 110. However, since moisture in the cathode gas flow path 110 is removed by the cathode gas, the amount of moisture contained in the cathode gas flow path 110 varies depending on the amount of generated water and the flow rate of the cathode gas. Therefore, depending on the flow rate of the cathode gas, drying of the cathode gas flow path 110 and flooding are likely to occur in the cathode gas flow path 110. The adjustment of the water content of the cathode gas flow path 110 by the fuel cell system 10 will be described in detail later. In this specification, the water content of the fuel cell stack 100 means the water content of the cathode gas flow path 110.

The cathode gas supply/discharge system 200 supplies the cathode gas to the fuel cell stack 100 and discharges the cathode gas from the fuel cell stack 100. The cathode gas supply/discharge system 200 includes a cathode gas supply pipe 210, a flow rate sensor 220, an air compressor 230, and a cathode gas discharge pipe 240.

The cathode gas supply pipe 210 supplies the cathode gas outside the fuel cell system 10 to the fuel cell stack 100. The cathode gas supply pipe 210 includes a first cathode gas supply pipe 211 that connects the outside and the inlet of the air compressor 230, and a second cathode gas supply pipe 212 that connects the outlet of the air compressor 230 and the inlet of the cathode gas flow path 110. Accordingly, the cathode gas supply pipe 210 supplies the cathode gas supplied from the outside by the air compressor 230 to the cathode gas flow path 110.

The flow rate sensor 220 acquires a flow rate of the cathode gas. More specifically, the flow rate sensor 220 measures the flow rate of the cathode gas flowing from the first cathode gas supply pipe 211 toward the air compressor 230. The flow rate sensor 220 sends the acquired flow rate to the control unit 500.

The air compressor 230 regulates the flow rate of the cathode gas flowing into the fuel cell stack 100. More specifically, the air compressor 230 compresses the cathode gas from the first cathode gas supply pipe 211 and discharges the cathode gas to the second cathode gas supply pipe 212. The air compressor 230 adjusts the flow rate of the cathode gas by compressing the cathode gas in accordance with an instruction from the control unit 500.

The output voltage Vf of the fuel cell stack 100 is adjusted by adjusting the flow rate of the cathode gas. The control of the electric power of the fuel cell system 10 will be described in detail later. Further, by adjusting the flow rate of the cathode gas, the water content of the fuel cell stack 100 is adjusted as described above.

The cathode gas discharge pipe 240 discharges the cathode gas discharged from the fuel cell stack 100 to the outside of the fuel cell system 10.

The anode gas supply/discharge system 300 supplies the anode gas to the fuel cell stack 100 and discharges the anode gas from the fuel cell stack 100. The anode gas supply/discharge system 300 includes an anode gas tank, an anode gas pump, and the like. Further, the anode gas supply/discharge system 300 includes a supply pipe, an exhaust pipe, and the like that allow the anode gas supplied from the anode gas tank to flow through the anode gas flow path 120. However, in order to facilitate understanding of the technology, the configuration of the anode gas supply/discharge system 300 is not shown in FIG. 1.

The output circuit 400 supplies power from the fuel cell stack 100 according to the requested power of the load device 440. The output circuit 400 includes a voltage sensor 410, a current sensor 420, an output adjustment unit 430, and a load device 440.

The voltage sensor 410 acquires an output voltage Vf of the fuel cell stack 100. The voltage sensor 410 sends the acquired output voltage Vf to the control unit 500.

The current sensor 420 acquires an output current If of the fuel cell stack 100. The current sensor 420 sends the acquired output current If to the control unit 500.

The output adjustment unit 430 adjusts the output power P1 of the fuel cell stack 100 in accordance with the power requested from the load. Specifically, the output adjustment unit 430 is a DCDC converter. The output adjustment unit 430 is connected to an output of electric power of the fuel cell stack 100. The output adjustment unit 430 extracts a current from the fuel cell stack 100 in accordance with a command value of the current of the control unit 500. Further, the output adjustment unit 430 transforms the output voltage Vf of the fuel cell stack 100 into a voltage requested by the load device 440. For example, the driving device of the motor included in the load device 440 requires a higher voltage than the output voltage Vf of the fuel cell stack 100. For this reason, the output adjustment unit 430 boosts the output voltage Vf of the fuel cell stack 100 to a voltage requested by the drive device of the motor. The control of the output adjustment unit 430 will be described in detail later. The “output adjustment unit” is also referred to as “FDC”.

The load device 440 consumes the load power P2 output from the output adjustment unit 430. The load device 440 includes, for example, a drive device for a vehicle including a motor and a drive circuit for a motor, an air compressor 230, an anode gas pump, and the like. The load device 440 sends necessary information on the load power P2 to the control unit 500. In this specification, the load power P2 required for the load device 440 is referred to as requested power.

The control unit 500 controls the fuel cell system 10. The control unit 500 is configured as a logic circuit mainly including a microcomputer. More specifically, the control unit 500 includes a CPU, a ROM, a RAM, and input/output ports for inputting and outputting various types of signals. CPU executes a preset control program. ROM stores in advance control programs, control data, and the like required for executing various arithmetic processes in CPU. RAM temporarily reads and writes various types of data required for performing various types of arithmetic operations in CPU. The function of the control unit 500 will be described below.

The control unit 500 controls the flow rate of the cathode gas by the air compressor 230 to perform either a raising operation of the air stoichiometric ratio or a lowering operation of the air stoichiometric ratio. The air stoichiometric ratio is a ratio of the amount of the cathode gas actually supplied to the fuel cell stack 100 to the minimum amount of the cathode gas required to generate the requested electric power. That is, the air stoichiometric ratio is 1.0 or more.

The raising operation of the air stoichiometric ratio is an operation of causing the air compressor 230 to supply the cathode gas so that the air stoichiometric ratio becomes the first air stoichiometric ratio. Specifically, the first air stoichiometric ratio is 1.5. The first air stoichiometric ratio is based on an air stoichiometric ratio at which the power consumption of the drive device of the vehicle is maximized. That is, the first air stoichiometric ratio is based on an air stoichiometric ratio that maximizes the electric power obtained by excluding the electric power consumed by the air compressor 230, the cathode pump, and the like from the output power P1 of the fuel cell stack 100.

The lowering operation of the air stoichiometric ratio is an operation of causing the air compressor 230 to supply the cathode gas so that the air stoichiometric ratio becomes a second air stoichiometric ratio lower than the first air stoichiometric ratio. For example, when the first air stoichiometric ratio is 1.5, the second air stoichiometric ratio is a value included in a range of 1.2 or more and 1.3 or less.

The lowering operation of the air stoichiometric ratio reduces the flow rate of the cathode gas compared to the case of the first air stoichiometric ratio. The decrease in the flow rate of the cathode gas reduces the amount of water removed from the fuel cell stack 100. That is, since the amount of water contained in the fuel cell stack 100 increases, drying of the fuel cell stack 100 is prevented. However, flooding is likely to occur due to an increase in the water content of the fuel cell stack 100. Incidentally, the “operation of raising the air stoichiometric ratio” is also simply referred to as “raising operation”, and the “operation of lowering the air stoichiometric ratio” is also simply referred to as “lowering operation”.

Even in the case of the raising operation of the air stoichiometric ratio, the cathode gas supplied from the air compressor 230 is dried, and thus the fuel cell stack 100 may be partially dried. In particular, the inlet portion of the cathode gas flow path 110 may dry. In such a case, the fuel cell stack 100 is prevented from being dried by performing the lowering operation of the air stoichiometric ratio.

The control unit 500 further controls the output power P1 of the fuel cell stack 100 in accordance with the requested power of the load device 440. More specifically, the control unit 500 acquires information on the requested power from the load device 440. The control unit 500 controls the air compressor 230 based on a predetermined reference value of the output voltage Vf in accordance with the requested power. When the cathode gas is supplied to the fuel cell stack 100, the fuel cell stack 100 starts power generation, and thus an output voltage Vf is generated. Further, the control unit 500 controls the output adjustment unit 430 based on a predetermined reference value of the output current If in accordance with the requested power. That is, the output adjustment unit 430 extracts the output current If from the fuel cell stack 100 based on the reference value of the output current If to output an output current If corresponding to the reference value of the output current If. In addition, the control unit 500 acquires the output current If and the output voltage Vf by the voltage sensor 410 and the current sensor 420. The control unit 500 calculates the output power P1 based on the acquired output current If and the output voltage Vf. The control unit 500 calculates an output current If to be extracted by the output adjustment unit 430 based on the calculated difference between the output power Pl and the requested power. Therefore, the output adjustment unit 430 causes the fuel cell stack 100 to output the output power P1 of the fuel cell stack 100 according to the requested power.

### A-2. Method for Controlling Fuel Cell System

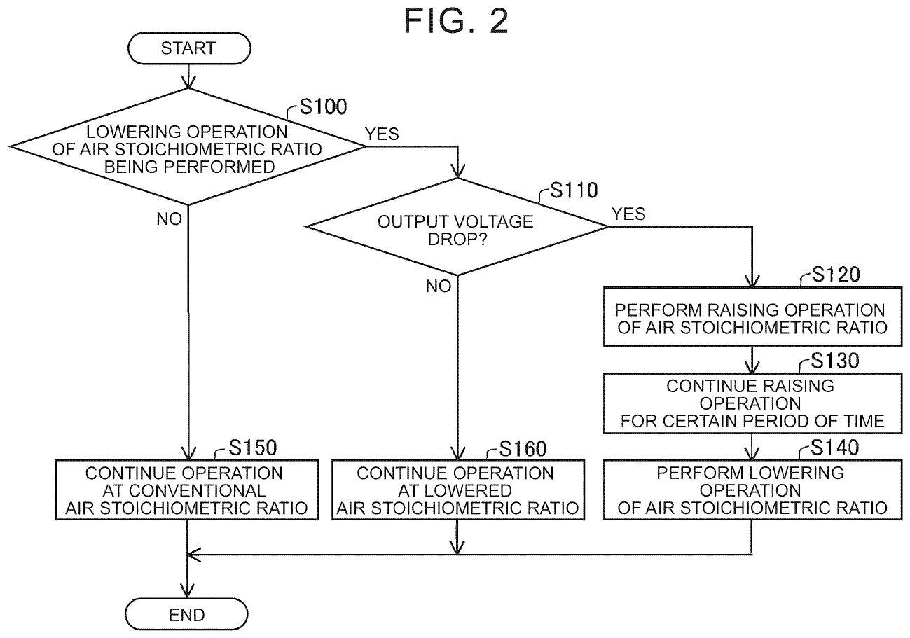

FIG. 2 is a flowchart illustrating a control method of the fuel cell system 10. Hereinafter, a method of controlling the fuel cell system 10 will be described. The control unit 500 repeatedly executes the following processing while the fuel cell system 10 is in operation.

In S100 of FIG. 2, it is determined whether the lowering operation of the air stoichiometric ratio is performed. That is, when the air stoichiometric ratio is not the second air stoichiometric ratio, the control unit 500 advances the process to S150. When the air stoichiometric ratio is the second air stoichiometric ratio, the control unit 500 advances the process to S110.

In S110 of FIG. 2, the control unit 500 determines whether or not the output voltage Vf of the fuel cell stack 100 has decreased. When the output voltage Vf is low, this occurs when a concentration-overvoltage is generated due to flooding. Specifically, the control unit 500 advances the process to S120 when the voltage sensor 410 satisfies the first condition including that the output voltage Vf of the fuel cell stack 100 is within the first range. The control unit 500 advances the process to S160 when the voltage sensor 410 satisfies the second condition including that the output voltage Vf of the fuel cell stack 100 is a value included in the second range higher than the first range.

The “second range higher than the first range” means that the lower limit of the second range is higher than the upper limit of the first range. The first range and the second range are defined by predetermined thresholds. More specifically, the threshold value or more is the second range, and the threshold value or less is the first range. The thresholds are set experimentally, for example, based on the smallest possible output voltage Vf rather than a sudden increase in the load-power P2.

The first condition may further include that the output voltage Vf is included in the first range for a predetermined second period of time. The second period of time is specifically a time based on the response speed of the air compressor 230. For example, the second period of time is four seconds. With such a configuration, the raising operation is not performed when the output voltage Vf is reduced to less than the second period of time. The output voltage Vf may instantaneously drop due to fluctuations in load power P2. Therefore, the fuel cell system 10 of the present disclosure can prevent the raising operation from being performed by mistake due to the instantaneous decrease in the output voltage Vf. In the present specification, the “second period of time” is also referred to as “determination time for prevention of erroneous determination”.

In S120 of FIG. 2, the control unit 500 performs the raising operation of the air stoichiometric ratio. That is, the control unit 500 increases the flow rate of the cathode gas by the air compressor 230 so that the air stoichiometric ratio becomes the first air stoichiometric ratio.

In S130 of FIG. 2, the control unit 500 continuously performs the raising operation so that the air stoichiometric ratio is maintained at the first air stoichiometric ratio for a predetermined first period of time. The first period of time is the time required to eliminate flooding. In the present specification, the “first period of time” is also referred to as “drainage time”. The drainage time is set experimentally according to the specifications of the fuel cell stack 100. For example, the drainage time is 30 minutes.

In S140 of FIG. 2, the control unit 500 performs the lowering operation of the air stoichiometric ratio after the first period of time elapses. That is, the control unit 500 reduces the flow rate of the cathode gas by the air compressor 230 so that the air stoichiometric ratio becomes the second air stoichiometric ratio.

In S150 of FIG. 2, the control unit 500 continues the operation so as to achieve the conventional air stoichiometric ratio. That is, the control unit 500 continues the operation so that the air stoichiometric ratio in S100 is maintained.

In S160 of FIG. 4, the control unit 500 continues the operation with the air stoichiometric ratio lowered.

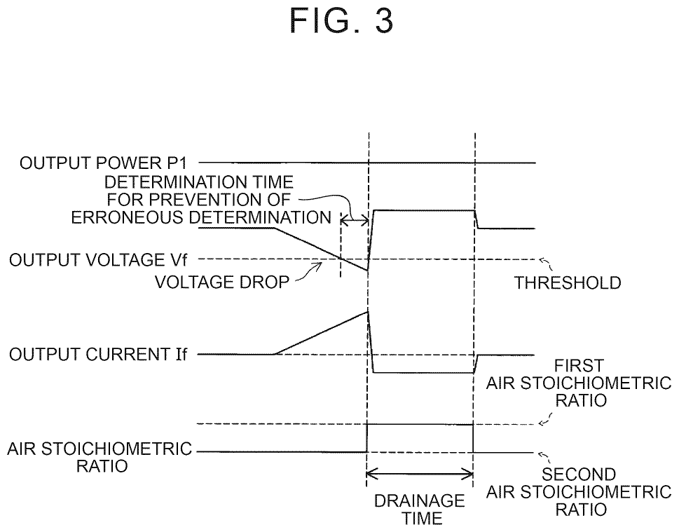

The above process is repeated while the fuel cell stack 100 outputs the output power P1. That is, after any of the processes in S140 to S160 of FIG. 3, the control unit 500 starts the process of S100.

As described above, in the case where the air stoichiometric ratio is the second air stoichiometric ratio, the flow rate of the cathode gas is lower than in the case where the air stoichiometric ratio is the first air stoichiometric ratio. As a result, the amount of water removed from the fuel cell is reduced, and thus drying of the fuel cell is prevented. However, in the case where the air stoichiometric ratio is the second air stoichiometric ratio, the amount of water contained in the fuel cell is increased, and thus the possibility that a concentration overvoltage due to flooding occurs is increased. The concentration overvoltage lowers the output voltage Vf of the fuel cell.

FIG. 3 is a diagram illustrating an output power P1 of the fuel cell system 10 when the output voltage Vf decreases. In the waveform of FIG. 3, the horizontal direction of the drawing indicates the elapse of time, and the vertical direction of the drawing indicates the magnitude of the value. In the fuel cell system 10, when the output voltage Vf is lower than the threshold value due to a decrease in the output voltage Vf due to the concentration overvoltage, the raising operation is performed so that the air stoichiometric ratio becomes the first air stoichiometric ratio. That is, the flow rate of the cathode gas increases.

As a result, as shown in FIG. 3, the air stoichiometric ratio, which is the second air stoichiometric ratio, becomes the first air stoichiometric ratio. Therefore, since the concentration overvoltage due to flooding is eliminated, the output voltage Vf increases. However, the determination of the decrease in the output voltage Vf is made on condition that the decrease in the output voltage Vf continues beyond the determination period for preventing erroneous determination.

As shown in FIG. 3, since the output adjustment unit 430 causes the fuel cell stack 100 to output the output power P1 satisfying the requested power, the output current If fluctuates due to the fluctuation in output voltage Vf. This keeps the output power P1 constant.

Therefore, the fuel cell system 10 of the present disclosure controls the flow rate of the cathode gas in accordance with the decrease in the output voltage Vf due to the concentration overvoltage. As a result, drying of the fuel cell can be prevented as compared with a configuration in which the flow rate of the cathode gas is controlled in order to prevent the concentration overvoltage. Moreover, in the fuel cell system 10 of the present disclosure, the flow rate of the cathode gas is increased according to the drop of the output voltage Vf. Therefore, the output of the fuel cell is less likely to become insufficient.

Further, in such a configuration, the raising operation is not performed when the output voltage Vf falls below the determination period for preventing erroneous determination. The output voltage Vf may instantaneously decrease due to, for example, fluctuations in requested power. Therefore, the fuel cell system 10 of the present disclosure can prevent the raising operation from being performed by mistake due to the instantaneous decrease in the output voltage Vf.

Further, as shown in FIG. 3, the fuel cell system 10 performs the lowering operation such that the air stoichiometric ratio, which was the first air stoichiometric ratio, becomes the second air stoichiometric ratio after the lapse of the drainage time. Thus, the fuel cell system 10 operates again to reduce drying of the fuel cell stack 100.

With such a configuration, the fuel cell system 10 of the present disclosure can prevent the fuel cell from drying after the lapse of the first period of time, as compared with a configuration in which the lowering operation is not performed.

### B. Modifications

(1) In the above embodiment, the first air stoichiometric ratio is 1.5. However, the first air stoichiometric ratio may be 1.5 or more. Further, in the above embodiment, the second air stoichiometric ratio is a value included in the range of 1.2 or more and 1.3 or less. However, the second air stoichiometric ratio may be 1.0 or more and less than 1.5.
(2) In the above embodiment, the control unit 500 does not perform the raising operation when the output voltage Vf drops for less than the determination period for preventing erroneous determination. However, the control unit 500 may perform the raising operation even if the output voltage Vf decreases less than the determination period for preventing erroneous determination. Such a configuration facilitates control.
(3) In the above embodiment, the control unit 500 performs the lowering operation after the elapse of the first period of time. However, the control unit 500 may not perform the lowering operation after the lapse of the first period of time. Even when the lowering operation is not performed, the dry state of the fuel cell stack 100 is reduced because the lowering operation is already performed.
(4) In the above-described embodiment, the control unit 500 may be configured by a plurality of microcomputers. More specifically, the function of the control unit 500 that performs the raising operation of the air stoichiometric ratio or the lowering operation of the air stoichiometric ratio or the control of the output adjustment unit 430 may not be realized by one microcomputer.

The present disclosure is not limited to the embodiments above, and can be implemented with various configurations without departing from the scope of the present disclosure. For example, the technical features of the embodiments corresponding to the technical features in each mode described in the section of the summary of the disclosure may be replaced or combined appropriately to solve some or all of the above issues or to achieve some or all of the above effects. When the technical features are not described as essential in this specification, the technical features can be deleted as appropriate.

What is claimed is:

1. A fuel cell system comprising:
a fuel cell;
an air compressor that adjusts a flow rate of a cathode gas to be caused to flow into the fuel cell;
a flow rate sensor that acquires the flow rate of the cathode gas;
a voltage sensor that acquires an output voltage of the fuel cell; and
a control unit that controls the fuel cell system, wherein the control unit is configured to
perform either a raising operation or a lowering operation, the raising operation being an operation in which the air compressor is caused to supply the cathode gas so as to achieve a first air stoichiometric ratio that is an air stoichiometric ratio of 1 or more, and the lowering operation being an operation in which the air compressor is caused to supply the cathode gas so as to achieve a second air stoichiometric ratio that is an air stoichiometric ratio of 1 or more and less than the first air stoichiometric ratio, and
when the lowering operation is being performed,
perform the raising operation for a predetermined first period of time when a first condition is satisfied, the first condition including that the output voltage has a value in a first range, and
not perform the raising operation when a second condition is satisfied, the second condition including that the output voltage has a value in a second range that is higher than the first range.

2. The fuel cell system according to claim 1, wherein the first condition includes that the output voltage is in the first range for a predetermined second period of time.

3. The fuel cell system according to claim 2, wherein the control unit performs the lowering operation after a lapse of the first period of time.
